(19) United States
(12) Patent Application Publication
(10) Pub. No.: US 2005/0066859 A1
(43) Pub. Date: Mar. 31, 2005

(54) Incombustible composition, incombustible construction product using incombustible composition, and method of producing incombustible construction product

(75) Inventors: Sang-Hoon Lee, Seoul (KR); Jun-Han Choi, Goyang-Si (KR); Byung-Ick Yoon, Seoul (KR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Jun-Han CHOI

(21) Appl. No.: 10/949,363

(22) Filed: Sep. 27, 2004

(30) Foreign Application Priority Data
Sep. 29, 2003 (KR) 67417/03

(51) Int. Cl. C04B 14/00

(52) U.S. Cl. 106/705; 106/711

(57) ABSTRACT

Disclosed is an incombustible composition, an incombustible construction product using the incombustible composition, and a method of producing the incombustible construction product. The incombustible composition includes 1 to 80 wt % of organic or inorganic fiber, 1 to 80 wt % of fly ash or bottom ash, 1 to 80 wt % of fire-proofing agent, and 1 to 60 wt % of fire-retardant curing agent. Additionally, the method includes mixing components, constituting the incombustible composition, with each other, and shaping the incombustible composition using a roller press or an autoclave. Therefore, the incombustible composition is advantageous in that it is environmentally-friendly because it contains waste materials, and that it has excellent hardness, strength, and water resistance. Other advantages are that its production costs are relatively low, and that it has excellent incombustibility, depending on the contents of the components constituting the incombustible composition.

### TECHNICAL FIELD

The present invention pertains to an incombustible composition, an incombustible construction product using the incombustible composition, and a method of producing the incombustible construction product. More particularly, the present invention relates to an incombustible composition, which is used as construction finishing and interior materials, being safe from fire, preventing fires from spreading and preventing toxic gases from being generated from the construction finishing and interior materials when the construction finishing and interior materials are on fire, an incombustible construction product using the incombustible composition, and a method of producing the incombustible construction product.

### BACKGROUND ART

Up to now, MDF, plywood, a plaster board, and a wood-wool cement board have been used as representative construction finishing and interior materials in domestic and overseas construction fields.

However, the above construction materials have different physical properties and disadvantages. Accordingly, efforts have been made to develop various fire-retardant materials by properly controlling compositions of components constituting the construction materials so as to complement the construction materials with each other. However, these efforts are disadvantageous in that the developed fire-retardant materials do not have sufficient physical properties required for construction finishing and interior materials, but have the few desired physical properties, and thus, the use of the fire-retardant materials is applied to limited fields.

In order to better understand the background of the invention, a description will be given of conventional technologies regarding the construction materials, below.

Conventional developments of the fire-retardant materials are mostly focused on coating a fire-retardant pigment on or attaching a fire-retardant film to the MDF or plywood, having no fire-retardancy, while the amount of the fire-retardant pigment or the fire-retardant film is properly controlled, or on attaching a fire-retardant board or an incombustible steel or aluminum plate to the plaster board.

The MDF or plywood is produced by pressing and shaping wood chips using an organic adhesive, and most widely used as the construction finishing and interior materials. However, the MDF or plywood has no fire-retardancy, thereby catching fire easily.

To avoid the above disadvantage, an inorganic adhesive may be used instead of the organic adhesive. However, the MDF or plywood, produced using the inorganic adhesive, is disadvantageous in that layers constituting the MDF or plywood are easily separated from each other and the MDF or plywood is easily damaged, thereby reducing the productivity of the MDF or plywood. Additionally, because only the adhesive is made of an inorganic material and the MDF or plywood mostly consists of the combustible wood chips, the MDF or plywood has not sufficient fire-retardant ability (incombustibility, quasi-incombustibility, and fire-retardancy). Hence, it is difficult to commercialize the MDF or plywood using an inorganic adhesive.

As for the plaster board with fire-retardancy, technologies have been developed to attach the fire-retardant board to the plaster board and to attach the incombustible steel or aluminum plate to the plaster board. In this regard, the plaster board is disadvantageous in that a plaster, used as a main component of the plaster board, is relatively heavy, and it is impossible to process the plaster in order to use it as a construction finishing material. However, a technology of a material capable of being used instead of the plaster, has not yet been developed, and thus, the plaster board is still used as construction finishing and interior materials, having the fire-retardancy.

In addition, the wood-wool cement board has been used as the construction finishing and interior materials. The wood-wool cement board is produced by mixing various substances with cement. Examples of the above substances may include relatively light paper particles, perlites, Styrofoam particles, vermiculites, bottom ash, and a mixture thereof, and various additives may be added into the wool-wood cement board in accordance with the use of the wood-wool cement board.

However, the wood-wool cement board is used as construction exterior and ceiling materials rather than the construction finishing and interior materials because the wood-wool cement board has slightly different physical properties from a cement board. In other words, the wood-wool cement board does not serve to radically modify physical properties of the cement board.

Currently, an incombustible construction finishing and interior material is developed, which is produced by pressing and shaping incombustible alumina powder (Al₂O₃). However, the incombustible construction finishing and interior material, including the alumina powder, is more expensive than the MDF or plywood by ten times or more, and thus, it is only applied to special fields but scarcely used in general construction finishing and interior material.

According to the existing Building Standards Act and Fire Services Act in Korea, a finishing and interior material, used in buildings, must be incombustible, quasi-incombustible, or fire-retardant, and the buildings, larger than a predetermined scale, must include fire-proofing sections to prevent the fire from spreading and to shield persons from fire. As well, a fire door, made of a material capable of enduring fire for 30 minutes or one hour must be installed at the fire-proofing sections.

Furthermore, the legally regulated finishing and interior material is evaluated as three categories according to the KS (Korean Standard) F2271 method (a fire-retardant performance test method for construction materials): first-grade fire-retardancy (incombustible materials), second-grade fire-retardnacy (quasi-incombustible materials), and third-grade fire-retardancy (fire-retardant materials). Particularly, the fire door is evaluated as the first fire door, enduring fire for one hour, and the second fire door, enduring fire for 30 minutes, according to the KS F2257 method, and it is stated in the Building Standards Act that only the fire door, having performances satisfying the above standards, may be used in the buildings.

The Building Standards Acts of different countries may be slightly different from each other. However, all countries regulate the standards regarding the performances of the construction finishing and interior material, and the Building Standards Act of each country provides that only the materials, having the performances satisfying the above standards, may be applied to the buildings. The reason for this is that the use of the desirable construction finishing and interior material contributes to preventing the fire from spreading and to shielding persons in the buildings from toxic gases occurring due to fire.

However, most of the commercial construction finishing and interior materials insufficiently satisfy the above standards, and do not sufficient physical properties required to be used as the construction finishing and interior material even though they have incombustibility, quasi-incombustibility, or fire-retardancy.

Heretofore, the construction finishing and interior materials with excellent performance have not yet been developed even though many studies have been conducted to develop the construction finishing and interior materials, having incombustibility, quasi-incombustibility, or fire-retardancy. In detail, the MDF or plywood as described above is the most widely used as the construction interior material because the MDF or plywood is inexpensive and lightweight, has excellent processability, and ease of its use in building constructing is ensured. However, the MDF or plywood has poor water-resistance, and no incombustibility, quasi-incombustibility, or fire-retardancy, thereby catching fire easily and accelerating the spread of the fire. Accordingly, the use of the MDF or plywood is limited by the existing Building Standards Act in Korea.

In addition, the plaster board is made of waste chemical gypsum, discharged from a fertilizer plant or a power plant, plaster and the like. The plaster board is inexpensive, and has excellent processability. Further, ease of its use in building constructing is ensured, and the plaster board has incombustibility, quasi-incombustibility, or fire-retardancy. Hence, the plaster board is used as a representative construction finishing and interior material with incombustibility, quasi-incombustibility, or fire-retardancy. However, the plaster board is problematic in that it is very weak against water, easily damaged due to its poor strength, and brings about pollution because a lot of dust is created when it is processed and most of the used plaster board cannot be regenerated. Furthermore, it is difficult to shape the plaster board in various designs and to apply the plaster board to various fields because papers are attached to a surface of the plaster board.

As for the wood-wool cement board, it has excellent strength, water-resistance, and incombustibility, quasi-incombustibility, or fire-retardancy. However, the wood-wool cement board has poor processability, and is relatively heavy and easily damaged. As well, ease of its use in building constructing is not ensured. Therefore, the wood-wool cement board is used as exterior wall materials or surface materials of the buildings, but scarcely used as the construction finishing and interior materials.

### DISCLOSURE OF THE INVENTION

Accordingly, the present invention has been made keeping in mind the above problems, such as the poor heat-intercepting property of conventional construction finishing and interior materials and difficulty in applying the conventional construction finishing and interior materials to various fields, occurring in the prior art, and an object of the present invention is to provide an incombustible composition, which mostly consists of waste materials, and which is environmentally-friendly and inexpensive. In this regard, the incombustible composition has excellent hardness, strength, and water-resistance, and has fire-retardancy depending on the contents of components thereof.

Another object of the present invention is to provide a method of producing an incombustible construction product, having all desirable physical properties, required for construction material, as well as incombustibility, using an incombustible composition.

A further object of the present invention is to provide an incombustible construction product, produced according to the above method, which is used as construction finishing and interior core materials, being safe from fire, preventing fires from spreading and preventing toxic gases from being generated from the construction finishing and interior core materials when the construction finishing and interior core materials are on fire.

In order to accomplish the above object, the present invention provides an incombustible composition, including 1 to 80 wt % of organic or inorganic fiber, 1 to 80 wt % of fly ash or bottom ash, 1 to 80 wt % of fire-proofing agent, and 1 to 60 wt % of fire-retardant curing agent.

Furthermore, the present invention provides a method of producing an incombustible construction product, which includes providing the incombustible composition; mixing an organic or inorganic fiber, a fly ash or bottom ash, and a fire-proofing agent with each other using a mixer after being weighed, and spraying a fire-retardant curing agent and water onto a mixture to form a paste; pressing the paste using a roller press; and curing the pressed paste using a drier in which a temperature is controlled from 10 to 20° C.

As well, the present invention provides an incombustible construction product, which is shaped as the core material of a board constituting an aluminum or steel plate complex board, the main body and doors of a kitchen table, the main bodies and doors of built-in furniture, furniture, lavatory partitions, partition walls, an access floor, an OA floor, a stair board, a reinforced floor, or a ceiling finishing material.

### BEST MODE FOR CARRYING OUT THE INVENTION

An incombustible composition according to the present invention includes 1 to 80 wt % of organic or inorganic fiber (a), 1 to 80 wt % of fly ash or bottom ash (b), 1 to 80 wt % of fire-proofing agent (c), and 1 to 60 wt % of fire-retardant curing agent (d). Additionally, the incombustible composition of the present invention may further include an incombustible lightening agent (e), an additive, such as a curing acceleration binder, a surfactant, and/or a coloring agent, and water.

According to the present invention, it is preferable that the incombustible composition contains 1 to 80 wt % of organic or inorganic fiber (a). Examples of the organic fiber include paper fragments shattered into fibroid materials, shattered wood fragments, waste fibers, wood powder, rice bran, vegetable fibers, and a mixture thereof, and the inorganic fiber is exemplified by rock wool, glass wool, basaltic wool, ceramic wool, and a mixture thereof. In this regard, the above exemplified organic or inorganic fibers contain some waste materials.

The organic or inorganic fiber (a) is added into the incombustible composition to enable other components constituting the incombustible construction product, produced using the incombustible composition, to firmly combine with each other to constantly maintain a predetermined shape, such as a board, of the incombustible construction product even though the incombustible construction product has relatively low specific gravity. Accordingly, the organic or inorganic fiber (a) enables the incombustible construction product to be processed in various sizes, and serves to increase the attachment force of the incombustible construction product to screws when the incombustible construction product is attached to other members.

When the content of the organic or inorganic fiber (a) in the incombustible composition is less than 1 wt %, the incombustible construction product has improved fire-retardancy, but poor processability and attachment force to the screws due to the relatively high hardness thereof. On the other hand, when the content of the organic or inorganic fiber (a) in the incombustible composition is more than 80 wt %, the strength of the incombustible construction product is reduced to lower the dimensional stability of the incombustible construction product.

Additionally, the fly ash or bottom ash (b) is used to secure sufficient surface strength and a smooth surface of the incombustible construction product. At this time, the density, and surface and compression strengths of the incombustible construction product may be controlled in accordance with the content of fly ash or bottom ash (b) in the incombustible composition. In the present specification, the term “fly ash” means a relatively lightweight ash portion of remaining ash after the burning of coals used as a fuel in a steam power plant, the term “bottom ash” meaning ash portion heavier than fly ash.

Even though fly ash or bottom ash (b) have lighter specific gravity than the cement, the component (b) has relatively high specific gravity in comparison with other components constituting of the incombustible construction product. Hence, when the fly ash or bottom ash (b) content of the incombustible construction product is relatively high, it is difficult to accomplish the lightening of the incombustible construction product, but it is possible to obtain the strong incombustible construction product having the improved strength.

Hence, it is preferable that the fly ash or bottom ash content in the incombustible composition is 1 to 80 wt %. When the content of the fly ash or bottom ash (b) in the incombustible composition is less than 1 wt %, it is difficult to produce the smooth incombustible construction product having desired surface effect. On the other hand, when the content of the fly ash or bottom ash (b) is more than 80 wt %, the incombustible construction product is relatively high in terms of specific gravity, and easily damaged by a relatively weak impact.

The organic or inorganic fiber (a) constituting the incombustible construction product may be made of combustible materials. Hence, the fire-proofing agent (c), such as calcium carbonate, sodium bicarbonate, sodium carbonate, other carbonates, or a mixture thereof, may be added into the incombustible composition to minimize the combustion of the incombustible construction product or the occurrence of toxic gases when the incombustible construction product is on fire, thereby the incombustible construction product ensures the incombustibility or quasi-incombustibility. Furthermore, when the incombustible construction product, containing the fire-proofing agent (c), is on fire at a temperature of 500° C. or higher, the fire-proofing agent (c) is decomposed to allow carbon dioxide (CO₂) to flow out of the incombustible construction product, thereby extinguishing the fire. Accordingly, the incombustible construction product, containing the three components, that is, the organic or inorganic fiber (a), the fly ash or bottom ash (b), and the fire-proofing agent (c), is improved in terms of the fire-retardancy because of the fire-proofing agent (c). In other words, the quasi-incombustible construction product is improved to the incombustible construction product, and the fire-retardant construction product is improved to the quasi-incombustible or incombustible construction product.

At this time, it is preferable that the content of the fire-proofing agent (c) in the incombustible composition is 1 to 80 wt %. When the content of the fire-proofing agent (c) in the incombustible composition is less than 1 wt %, the incombustible composition does not secure a sufficient fire-proofing agent effect. On the other hand, when the content of the fire-proofing agent (c) is more than 80 wt %, the strength of the incombustible construction product is reduced.

In addition, the fire-retardant curing agent (d), such as sodium silicate, potassium silicate, or a mixture thereof, may be selectively added into the incombustible composition in an amount of 1 to 60 wt % to further improve incombustibility of the incombustible composition, containing the organic or inorganic fiber (a). In this regard, strength and processability, or the fire-retardancy of the construction product, produced using the incombustible composition, may be controlled in accordance with a content of the fire-retardant curing agent (d) in the incombustible composition.

When the content of the fire-retardant curing agent (d) in the incombustible composition is less than 1 wt %, other components constituting the incombustible composition are not sufficiently bound to each other to reduce strength and hardness of the incombustible construction product, thereby hindering the incombustible construction product from fulfilling its function. On the other hand, when the content of the fire-retardant curing agent (d) in the incombustible composition is more than 60 wt %, the incombustible construction product may be easily deformed due to a non-uniform surface curing speed distribution thereof.

Meanwhile, the incombustible lightening agent (e) may be selectively added into the incombustible composition to lighten the incombustible construction product. At this time, specific gravities of construction finishing and interior materials may be controlled according to the content of the incombustible lightening agent (e) in the incombustible composition. Examples of the incombustible lightening agent (e) include fine perlite particles, fine vermiculite particles, rockwool wastes, diatomites, zeolites, or a mixture thereof. In this respect, the waste fine perlite particles or waste fine vermiculite particles may be used as the incombustible lightening agent (e).

The content of the incombustible lightening agent (e) in the incombustible construction product may be 1 to 50 wt %. When the content of the incombustible lightening agent (e) in the incombustible composition is less than 1 wt %, the incombustible lightening agent (e) does not affect the specific gravity of the incombustible construction product and not fulfill its function. On the other hand, when the content of the incombustible lightening agent (e) is more than 50 wt %, the surface of the incombustible construction product becomes rough, the strength of the incombustible construction product is reduced, and other components constituting the incombustible composition are not uniformly mixed with each other, leading to a non-uniform distribution of the components in the incombustible composition.

Furthermore, 1 to 10 wt % of curing acceleration binder (f) may be selectively added into the incombustible composition to improve the productivity of the incombustible construction product and to minimize shrinkage and deformation of the incombustible construction product when the incombustible construction product is cured. At this time, the curing acceleration binder (f) serves to enable the fire-retardant curing agent (d) to be quickly dried. In this respect, examples of the curing acceleration binder (f) include magnesia, plaster, inorganic or organic acid mixtures, calcium silicate, or a mixture thereof. Further, the curing time of the incombustible construction product may be controlled according to the content of the fire-retardant curing agent (d) in the incombustible composition.

As well, the surfactant (g) may be selectively added into the incombustible composition to improve its adiabatic property, water resistance, and water repellence of the incombustible construction product, and to promote the lightening of the incombustible construction product. In this regard, the surfactant (g) may be exemplified by an alkylbenzene sulfonic acid-based surfactant, having relatively large surface tension, and functions to reduce resistance to water and water-absorptivity of the incombustible construction product, thereby enabling the shape of the incombustible construction product to be maintained in water. Furthermore, the surfactant (g) serves to increase the porosity of the incombustible construction product to form a plurality of air layers in the incombustible construction product. Thereby, the surfactant (g) improves adiabatic property of the incombustible construction product and contributes to lightening the incombustible construction product. At this time, it is preferable that the content of the surfactant (g) in the incombustible composition is 0.1 to 0.3 wt % because the strength of the incombustible construction product may be reduced according to the content of the surfactant (g).

Meanwhile, the components (a) and (b), constituting the incombustible composition, have dark gray colors, and significantly affect the color of the entire incombustible composition. If the color of the incombustible composition is dark gray, the application of the incombustible composition to various colors of construction finishing and interior materials is limited. Accordingly, 1 to 10 wt % of white inorganic coloring agent (h) may be added into the incombustible composition. In this regard, the white inorganic coloring agent (h) is resistant to the fire and conceals well the dark gray color of the incombustible composition. Additionally, examples of the white inorganic coloring agent (h) include titanium dioxide (TiO₂). In conclusion, the white inorganic coloring agent (h) enables the incombustible composition to have the light gray color, thereby providing ease of surface treatment of the incombustible construction product, such as painting and woodgrain coating of the incombustible construction product.

Particularly, red and yellow inorganic coloring agents (i) may be added into the incombustible composition while being mixed in a predetermined mixing ratio to allow the surface color of the incombustible construction product to vary. At this time, a separate coloring process of the incombustible construction product may be omitted.

As well, the incombustible composition according to the present invention may further contain 1 to 60 wt % of water. In detail, water is further added into the incombustible composition so as to smoothly mix the fire-retardant curing agent with other components in case that the fire-retardant curing agent is mixed with other components constituting the incombustible composition. When an amount of water added into the incombustible composition is less than 1 wt %, the mixing of the fire-retardant curing agent with other components is not sufficiently conducted because the paste is thick. On the other hand, when the content of water in the incombustible composition is more than 60 wt %, the drying time of the paste is undesirably long, and strength of the incombustible construction product is reduced after the paste is dried.

Hereinafter, a detailed description will be given of the production of the incombustible construction product using the incombustible composition according to the present invention, below. It is to be understood that modifications, regarding the production of the incombustible construction product, will be apparent to those skilled in the art without departing from the spirit of the invention.

The present invention provides a method of producing an incombustible core material interposed between construction interior boards with excellent incombustibility to improve adiabatic and fire resisting properties of the construction interior boards. The method includes providing the incombustible composition; mixing the organic or inorganic fiber, fly ash or bottom ash, and fire-proofing agent with each other using a mixer after they are weighed, and spraying water and a fire-retardant curing agent into a mixture to form a paste; pressing the paste using a roller press; and drying and curing the pressed paste using a drier in which a temperature is controlled within a range of 10 to 200° C.

The production of the incombustible core material will be described below.

<Production of a Construction Interior Core Material According to Wet Process>

The organic or inorganic fiber (a), fly ash or bottom ash (b), and fire-proofing agent (c), stored in a silo equipped with a measuring system, are fed into a mixing compartment to be mixed with each other using a strong air current generated by a 30 to 50 horsepower compressor, installed at a lower portion of the mixing compartment. At this time, the incombustible lightening agent (e), curing acceleration binder (f), and/or inorganic coloring agent (h) and/or (i) may be selectively added into the mixing compartment through the silo.

The main mixing of the above components is conducted using a mixer, and a predetermined amount of water is fed through a water inlet, positioned at an upper part of the mixer, into the mixing compartment. After the completion of the feeding of water into the mixing compartment, the fire-retardant curing agent (d) is sprayed through a spray nozzle into the mixing compartment. Subsequently, a diluted surfactant solution, produced by dissolving the surfactant (g) in water, and air may be selectively fed into a bubble generator to form bubbles, and the bubbles thusly formed are fed into the mixing compartment.

All of the components, fed into the mixing compartment, are mixed with each other for a predetermined time to form a paste.

The paste is shaped into a core material with a predetermined thickness using the roller press while it is moved on a conveyor.

The core material is cured using, for example, the drier in which the temperature is controlled within a range of 10 to 200° C. to accomplish the incombustible core material.

According to the present invention, an autoclave curing device may be used and a high frequency heating function may be provided to the roller press, so as to quickly evaporate the fire-retardant curing agent (d) and water.

The incombustible core material, produced according to the wet process, is very light, and is porous, having a plurality of air layers therein, thereby ensuring excellent adiabatic property.

Therefore, the construction product according to the present invention has excellent incombustibility or fire-retardancy, adiabatic property, and physical properties. Additionally, in case the construction product is used as the core material of incombustible interior and exterior boards, constituting a fire door, a fire wall, an aluminum or steel plate complex board, a main body and doors of a kitchen table, main bodies and doors of built-in furniture, furniture, a lavatory partition, a partition wall, an access floor, an OA floor, a stair board, a reinforced floor, and a ceiling finishing material, the above construction interior and exterior products. Including the core materials, these items have excellent incombustibility, adiabatic property, and economic efficiency, and are efficiently lightened.

Having generally described this invention, a further understanding can be obtained by reference to examples which are provided herein for the purposes of illustration only and are not intended to be limiting unless otherwise specified.

Physical properties of samples according to the examples are evaluated as follows.
1) Incombustibility, quasi-incombustibility, and fire-retardancy: the samples are evaluated in three categories according to a KS F2271 method (a fire-retardant performance test method for construction materials): first-grade fire-retardancy (incombustible materials), second-grade fire-retardnacy (quasi-incombustible materials), and third-grade fire-retardancy (fire-retardant materials)
2) Specific gravity and density: The specific gravities and densities of the samples are measured according to a KS L5316 method (test method of physical properties of plaster boards)
3) Fire resistance: The fire resistances of the samples are evaluated according to a KS F3507 method (plaster boards)
4) Submergence stability: The submergence stabilities of the samples are evaluated according to the KS F3507 method (plaster boards)

As for the incombustibility, quasi-incombustibility, or the fire-retardancy of each construction product, which is considered as the most important factor, to be accomplished in the present invention, the construction products, produced according to the wet process in the examples, were evaluated in three categories according to the KS F2271 method: first-grade fire-retardancy (incombustible materials), second-grade fire-retardnacy (quasi-incombustible materials), or third-grade fire-retardancy (fire-retardant materials). These evaluations were conducted according to the contents of components constituting the construction products and the type of construction products.

Furthermore, a weight per unit area of each construction product was measured, and a weight change of the construction product according to a mixing ratio of the components was measured. Additionally, stability of each construction product against fire was evaluated by use of fire resistance of the construction product.

Particularly, submergence stabilities of the construction products were evaluated because it is required that most of the construction finishing and interior materials have submergence stabilities.

### EXAMPLES 1 TO 3

An organic or inorganic fiber (a), a fly ash or bottom ash (b), and a fire-proofing agent (c), stored in a silo equipped with a measuring system, were fed into a mixing compartment to be mixed using a strong air current generated by a 30 to 50 horsepower compressor, installed at a lower portion of the mixing compartment. At this time, an incombustible lightening agent (e) may be selectively added into the mixing compartment through the silo, and the above components were fed into the mixing compartment in amounts as described in the following Table 1.

The main mixing of the components was conducted using a mixer, and a predetermined amount of water was fed through a water inlet, positioned at an upper part of the mixer, into the mixing compartment. After the completion of the feeding of water into the mixing compartment, a fire-retardant curing agent (d) was sprayed through a spray nozzle into the mixing compartment.

All of the components, fed into the mixing compartment, were mixed with each other for ten minutes to form a paste. The paste was shaped into a core material with a thickness of 20 m/m using a roller press while it is moved on a conveyor. The core material was dried and cured using a drier at about 100° C. for 12 hours to accomplish an incombustible core product.

### EXAMPLE 4

An organic or inorganic fiber (a), a fly ash or bottom ash (b), a fire-proofing agent (c), and an incombustible lightening agent (e), stored in a silo equipped with a measuring system, were fed into a mixing compartment to be mixed using a strong air current generated by a 30 to 50 horsepower compressor, installed at a lower portion of the mixing compartment. At this time, the above components were fed into the mixing compartment in amounts as described in the following Table 1.

The main mixing of the components was conducted using a mixer, and a predetermined amount of water was fed through a water inlet, positioned at an upper part of the mixer, into the mixing compartment. After the completion of the feeding of the water into the mixing compartment, a fire-retardant curing agent (d) was sprayed through a spray nozzle into the mixing compartment. Subsequently, a diluted surfactant solution, produced by dissolving 20 g of surfactant (g) in 1,000 g of water, and air were fed into a bubble generator to form bubbles, and the bubbles thusly formed were fed into the mixing compartment.

All of the components, fed into the mixing compartment, were mixed with each other for ten minutes to form a paste. The paste was shaped into a core material with a thickness of 20 m/m and a size of 500 mm×800 mm using a roller press while-it is moved on a conveyor. The core material was dried and cured using a drier at about 100° C. for 12 hours to accomplish an incombustible core product.

Physical properties of the incombustible core products in the examples 1 to 4 were evaluated according to the above evaluation methods, and the results are described in the following Table 1.

TABLE 1
Physical properties of the incombustible construction products produced
according to the wet process

| | | | | | | | | | Physical properties of the | | | |
|---|---|---|---|---|---|---|---|---|---|---|---|---|
| | Composition (wt %) | | | | | | | | construction products | | | |
| | ¹(a) | ²(b) | ³(c) | ⁴(d) | ⁵(e) | Water | ⁶Sur. | ⁷Shap. | ⁸Fire | ⁹Sp. | ¹⁰Subm. | ¹¹Fire res. |
| Ex. 1 | 50 | 5 | 5 | 30 | — | 10 | — | Core | 1^{st} | 0.417 | Unstable | Incombustible |
| | | | | | | | | material | grade | | | |
| Ex. 2 | 40 | 15 | 5 | 30 | — | 10 | — | Core | 1^{st} | 0.553 | Stable | Incombustible |
| | | | | | | | | material | grade | | | |
| Ex. 3 | 30 | 20 | 10 | 25 | 5 | 10 | — | Core | 1^{st} | 0.685 | Stable | Incombustible |
| | | | | | | | | material | grade | | | |
| Ex. 4 | 29.8 | 20 | 10 | 25 | 5 | 10 | 0.2 | Core | 1^{st} | 0.405 | Stable | Incombustible |
| | | | | | | | | material | grade | | | |

¹(a): component (a), shattered rock wool,
²(b): component (b), fly ash,
³(c): component (c), calcium carbonate,
⁴(d): component (d), sodium silicate liquid containing 50% of solids,
⁵(e): component (e), fine perlite particle,
⁶Sur.: surfactant
⁷Shap.: shape of the construction product,
⁸Fire: fire-retardancy,
⁹Sp.: density/specific gravity
¹⁰Subm.: submergence stability
¹¹Fire res.: fire resistance

From the Table 1, it can be seen that the incombustible core products according to the examples 1 to 3 are relatively lightweight, each have a weight per unit area of 0.4 to 0.7 and first-grade fire-retardancy. Additionally, the fire resistances of the incombustible core products according to the examples. 1 to 3 are evaluated having incombustibility, and thus, are useful as construction finishing and interior core materials.

In the case of the example 4, the incombustible core product is lightweight due to bubbles therein and has excellent hardness at a surface thereof even though a content of the shattered rock wool is reduced and the content of fly ash increases.

Furthermore, higher content of the fly ash in the incombustible composition brings about a higher specific gravity of the incombustible core product, and higher content of shattered rock wool in the incombustible composition leads to lower submergence stability of the incombustible core product.

Industrial Applicability

As described above, the present invention provides an incombustible composition used to produce an incombustible/quasi-incombustible core material. In this regard, 1 to 70 wt % of the incombustible composition may be made of a waste material. Accordingly, the incombustible composition of the present invention is advantageous in that the production costs are reduced, and that it is useful as a construction finishing and interior material because no fire and toxic gases occur when the board or square timber is on fire.

Other advantages are that the incombustible composition has excellent processability (saw processing, screwing, and the like), and that an incombustible construction product, produced using the incombustible composition, has excellent strength and water resistance. In addition, the incombustible construction product is not easily deformed, thereby being applied to various construction core materials. In case that the incombustible construction product is applied to core materials of construction finishing and interior materials, the incombustible construction core materials serve to prevent a fire from spreading and to shield persons from toxic gases generated by fire when the incombustible construction finishing and interior materials are on fire, thereby providing a safer environment.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. An incombustible composition, comprising 1 to 80 wt % of organic or inorganic fiber, 1 to 80 wt % of fly ash or bottom ash, 1 to 80 wt % of fire-proofing agent, and 1 to 60 wt % of fire-retardant curing agent.

2. The incombustible composition as set forth in claim 1, wherein the organic fiber is paper fragments shattered into fibroid materials, shattered wood fragments, waste fibers, wood powder, rice bran, vegetable fibers, or a mixture thereof, and the inorganic fiber is rock wool, glass wool, basaltic wool, ceramic wool, or a mixture thereof.

3. The incombustible composition as set forth in claim 1, wherein the fire-proofing agent is calcium carbonate, sodium bicarbonate, sodium carbonate, other carbonates, or a mixture thereof.

4. The incombustible composition as set forth in claim 1, wherein the fire-retardant curing agent is sodium silicate, potassium silicate, or a mixture thereof.

5. The incombustible composition as set forth in claim 1, further comprising 1 to 50 wt % of incombustible lightening agent selected from the group consisting of fine perlite particles, fine vermiculite particles, rockwool wastes, diatomites, zeolites, and a mixture thereof.

6. The incombustible composition as set forth in claim 1, further comprising 1 to 10 wt % of additive selected from the group consisting of a curing acceleration binder, a surfactant, an inorganic coloring agent, and a mixture thereof, and/or 1 to 60 wt % of water.

7. The incombustible composition as set forth in claim 6, wherein the curing acceleration binder is magnesia, plaster, inorganic or organic acid mixtures, calcium silicate, or a mixture thereof.

8. The incombustible composition as set forth in claim 6, wherein the inorganic coloring agent is titanium dioxide (TiO₂).

9. A method of producing an incombustible construction product, comprising:
providing the incombustible composition according to claim 1;
mixing an organic or inorganic fiber, a fly ash or bottom ash, and a fire-proofing agent with each other using a mixer after being weighed, and spraying a fire-retardant curing agent and water onto a mixture to form a paste;
pressing the paste using a roller press; and
drying and curing the pressed paste using a drier in which a temperature is controlled from 10 to 200° C.

10. The method as set forth in claim 9, wherein the roller press has a high frequency heating function.

11. The method as set forth in claim 9, further comprising using an autoclave curing device to quickly evaporate the fire-retardant curing agent and water.

12. The method as set forth in claim 9, wherein the incombustible construction product is a construction finishing or interior core material.

13. The method as set forth in claim 9 or 11, further comprising feeding a mixture of water and a surfactant, and air into a bubble generator to form bubbles, and adding the bubbles into the paste, before the paste is transmitted to the roller press or autoclave curing device.

14. An incombustible construction product produced according to the method of any one of claims 9 to 12.

15. The incombustible construction product as set forth in claim 14, comprising a core material of a board constituting a fire door, a fire wall, an aluminum or steel plate complex board, a main body and doors of a kitchen table, main bodies and doors of built-in furniture, furniture, a lavatory partition, a partition wall, an access floor, an OA floor, a stair board, a reinforced floor, or a ceiling finishing material.
